(19) United States
(12) Patent Application Publication
(10) Pub. No.: US 2026/0180919 A1
(43) Pub. Date: Jun. 25, 2026

(54) CONGESTION-BASED NETWORK OPTIMIZATION FOR GPU COMMUNICATION

(71) Applicant: Hewlet Packard Enterpsise Development LP, Spring, TX (US)

(72) Inventors: Minimol Thomas, San Jose, CA (US); Uyen Tu Chau, Roseville, CA (US); Chinlin Chen, San Jose, CA (US); Seetharam Pranihith Venuturupalli, Roseville, CA (US)

(21) Appl. No.: 18/988,510

(22) Filed: Dec. 19, 2024

(51) Int. Cl. H04L 47/762; H04L 43/0876

(52) U.S. Cl. CPC H04L 47/762; H04L 43/0876

(57) ABSTRACT

According to an implementation, a system and method optimize network performance for AI/ML workloads in data centers. Network switches collect telemetry data, which a management platform analyzes to identify congestion between processing units. The management platform determines optimization settings, such as load balancing and flow control adjustments, and applies them to the switches, improving network performance. Visualizations of network conditions can be generated for monitoring and management. The system can optimize processing unit utilization and efficiency in distributed AI/ML computing environments by adapting optimization settings based on continuous performance monitoring.

### BACKGROUND

High-performance computing environments rely on efficient GPU-to-GPU communication to process AI and ML workloads. Modern data center networks support distributed GPU-based computation, in which multiple graphics processing units (GPUs) exchange large volumes of data during artificial intelligence (AI) and machine learning (ML) processing cycles. The communication patterns involve frequent data exchanges between GPUs as they perform distributed training and inference operations.

The workloads generate collective communication patterns, where each GPU transmits computational results to other GPUs in the cluster. The resulting high-bandwidth traffic flows traverse multiple paths between source and destination devices through intermediate switches in spine-leaf architectures. Data transfers occur over a network infrastructure, including multiple switches arranged in spine-leaf topologies. The network paths between GPUs can vary based on the spine-leaf architecture, affecting how the high-bandwidth traffic flows are distributed across the available infrastructure, creating substantial demands on the network infrastructure.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is a network system, according to an implementation;

FIG. 2 is a flowchart of an implementation method for visualizing workloads and flow paths;

FIG. 3 is a flowchart of an implementation method for dynamic traffic congestion identification;

FIG. 4 is a flowchart of an implementation method for network optimization; and

FIG. 5 is a flowchart of an implementation method for optimizing network performance for a workload.

### DESCRIPTION

The following disclosure provides many different examples for implementing different features. Specific examples of components and arrangements are described below to simplify the present disclosure. These are, of course, merely examples and are not intended to be limiting.

The particular implementations are merely illustrative of specific configurations and do not limit the scope of the claimed implementations. Features from different implementations may be combined to form further examples unless noted otherwise. Various implementations are illustrated in the accompanying drawing figures, where identical components and elements are identified by the same reference number, and repetitive descriptions are omitted for brevity.

Variations or modifications described in one of the implementations may also apply to others. Further, various changes, substitutions, and alterations can be made herein without departing from the spirit and scope of this disclosure as defined by the appended claims.

While the technical aspects are described primarily in the context of data center networks supporting graphics processing unit (GPU)-based artificial intelligence (AI) and machine learning (ML) workloads, these aspects may also apply to other high-performance computing environments with distributed processing needs. In particular, aspects of the disclosure may similarly apply to storage networks handling large data transfers, high-frequency trading systems requiring low-latency communication, and cloud computing infrastructures supporting real-time data analytics. The techniques for analyzing network telemetry and optimizing traffic flows can benefit any computing environment where multiple processing elements exchange substantial amounts of data through a spine-leaf network architecture.

In implementations, a system and method are proposed for optimizing network performance for artificial intelligence (AI) and machine learning (ML) workloads in data centers. AI/ML workloads involve frequent exchanges of large volumes of data between graphics processing units (GPUs) as they perform distributed training and inference. These exchanges generate high-bandwidth traffic flows that traverse multiple paths through switches arranged in spine-leaf architectures.

In implementations, the proposed system collects comprehensive telemetry data from the switches, such as flow information and per-hop latency measurements as traffic moves through the network. A centralized software component, which can be cloud-based or on-premises, analyzes the telemetry data to identify congestion bottlenecks. It can establish a static or dynamic latency baseline and flag congestion when the measured latency exceeds an adaptive threshold.

In one or more implementations, the centralized component can visually represent the network topology, traffic flows, and congested paths. The visualization can enable network administrators to understand the current issues and review the system's recommended optimizations. The system proposes network optimization techniques to mitigate congestion, such as configuring explicit congestion notification (ECN), priority flow control (PFC), and dynamic load balancing (DLB) on the switches.

In an implementation, with the administrator's approval, the centralized component can deploy the recommended configurations to the switches via, for example, their APIs. This optimizes the network in real time to accommodate the demands of the AI/ML workloads. The system can continuously monitor the network and dynamically adjust its recommendations in response to evolving conditions.

Software components can implement the telemetry collection, analysis, and network optimization and do not require specialized hardware beyond the switches themselves. The approach can scale to varying-sized networks and adapt its algorithms to network topologies and traffic patterns. The system can maximize the utilization and performance of costly GPU resources by dynamically optimizing the network based on real-time telemetry and AI/ML-aware recommendations. These and additional details are discussed below.

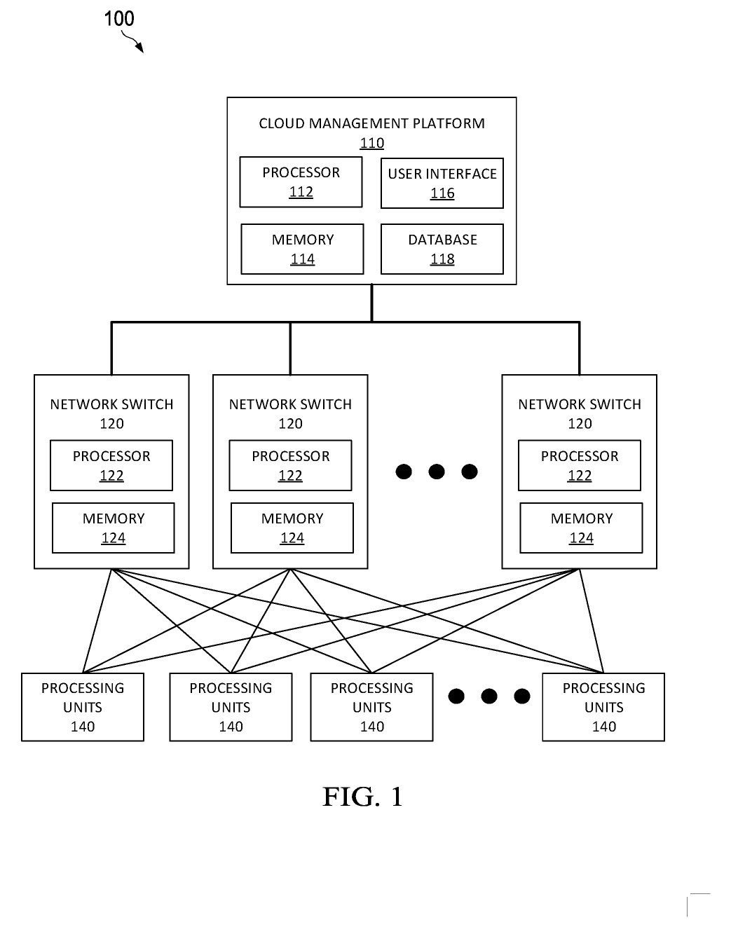

FIG. 1 illustrates a network system 100, according to an implementation. The network system 100 includes a cloud management platform 110, multiple network switches 120, and multiple processing units 140, which may (or may not) be arranged as shown. Network system 100 may include additional components not shown, such as firewall units, routers, interfaces, and the like.

In one or more implementations, the network system 100 is configured to collect telemetry data from network switches 120, analyze the data to identify performance bottlenecks and optimize network configurations to ensure efficient communication between the processing units 140 during AI/ML workloads.

In an implementation, the cloud management platform 110 includes a processor 112, a memory 114, a user interface 116, and a database 118. The processor 112 is coupled to the memory 114, the user interface 116, and the database 118. In an implementation, the processor 112 is a central processing unit (CPU).

The cloud management platform 110 is coupled to the network switches 120 through network connections. In an implementation, the connections are Ethernet. The processing units 140 can be coupled to the network switches 120 in a spine-leaf architecture. The network switches 120 can be coupled to each other in a spine-leaf topology. In implementations, the processing units 140, which can be hosts or servers, are coupled to a pair of network switches 120, considered the Top of Rack (ToR) switches. In implementations, the processing units 140 can be coupled to the network switches 120 using a rail-optimized topology. This arrangement allows the cloud management platform 110 to collect telemetry data from network switches 120, analyze network performance, and optimize traffic flow between processing units 140.

Each network switch 120 includes a processor 122 and a memory 124. The processor 122 is coupled to the memory 124. In an implementation, the processor 122 is a switch ASIC.

Processor 122 in each network switch 120 executes instructions to gather and process network data. This data can include network performance metrics and virtualization data. In an implementation, network performance metrics include, but are not limited to, latency measurements, queue depths, port utilization statistics, and network flow information.

The processor 122 can use various protocols to collect network traffic flow data. In an implementation, processor 122 uses Internet Protocol Flow Information Export (IPFIX) to collect detailed data about communication patterns between processing units 140 during collective communication operations in AI/ML workloads.

The processor 122 can capture latency data at each hop as traffic traverses the network. In an implementation, processor 122 employs in band flow analyzer (IFA) capabilities to identify congestion points and bottlenecks. The processor 122 can generate congestion notifications when certain thresholds are exceeded. In an implementation, the processor 122 generates notifications when queue usage exceeds specified thresholds.

The collected telemetry data can be stored in the memory 124 of each network switch 120. This data can be used to configure various traffic management features. In an implementation, the features include but are not limited to Explicit Congestion Notification (ECN) for early congestion warnings, Priority Flow Control (PFC) for lossless networking, and Dynamic Load Balancing (DLB) to distribute traffic evenly across available network paths.

The processor 122 can track virtualized computing resources to correlate application behavior with network performance. In an implementation, processor 122 monitors virtual machine (VM) state information through VM monitoring agents that interface with vSphere.

In implementations, each processing unit 140 includes processing cores and memory. In an implementation, the processing units are graphics processing units (GPUs). The processing units 140 operate as distributed computing nodes, processing AI/ML workloads and exchanging results through the network switches 120. The communication between processing units 140 can generate high-bandwidth traffic called elephant flows. In an implementation, data flows between GPUs can exceed 1GB per 10 seconds during collective communication phases.

Efficient network communication is crucial for maintaining GPU processing performance. In an implementation, the processing units 140 use Remote Direct Memory Access over Converged Ethernet version 2 (RoCEv2) protocol for high-throughput, low-latency data transfers.

The processor 112 in the cloud management platform 110 can analyze the telemetry data from the network switches 120 to identify performance issues and optimize traffic flow. It can correlate various data types to map communication patterns between processing units 140. In an implementation, the processor 112 correlates VM state information with IPFIX and IFA data.

The processor 112 can employ various methods to detect congestion while maintaining accurate baseline measurements. In an implementation, processor 112 uses standard deviation calculations and excludes latency values that indicate congestion conditions from baseline calculations.

The processor 112 can generate visual representations of network conditions and traffic patterns. In an implementation, the processor 112 processes per-hop latency data to create topology-based visualizations showing flow paths, congestion status, latency measurements, and traffic patterns. These visualizations can be presented through the user interface 116. In an implementation, the visualizations include circular diagrams showing GPU-to-GPU communication patterns and detailed path analysis views highlighting congested network segments.

Based on the analysis results, processor 112 can adapt network configurations to optimize traffic flow. In an implementation, the processor 112 configures traffic management features such as ECN, PFC, and DLB and pushes these configurations to the network switches 120 through APIs.

The database 118 can store various data types from the network switches 120. In an implementation, the stored data can include network performance data, telemetry information, and configuration parameters such as IPFIX flows, VM state information, per-hop latency measurements, and flow analysis results. The processor 112 uses this data to generate visualizations, identify optimization opportunities, and make network configuration decisions.

The user interface 116 enables administrators to interact with the network system 100. It presents visualization views generated by the processor 112. In an implementation, these views can include topology views highlighting congestion, circular diagrams displaying GPU-to-GPU communication patterns, and detailed path analysis views showing congested flows and latency measurements. The user interface 116 can also display optimization recommendations and provide a configuration workflow for administrators to implement changes.

Although the management platform is referred to as a cloud management platform 110, it should be noted that in some implementations, it can be implemented on-premises, within the same data center as the network switches 120 and processing units 140, rather than in a cloud environment. The management platform's functionality remains the same, regardless of its deployment location.

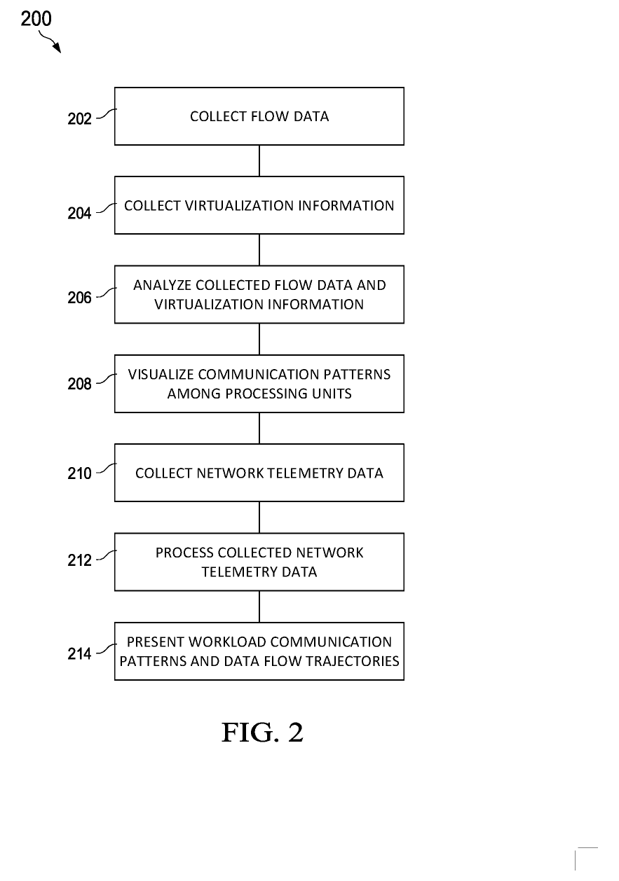

FIG. 2 illustrates a flowchart of an implementation method 200 for visualizing workloads and flow paths. The method 200 can be performed by the network system 100 described in FIG. 1. It provides a powerful and flexible way to visualize and analyze network data in the context of specific workloads and applications. By collecting and processing flow data, virtualization information, and network telemetry data, network system 100 can provide detailed and actionable insights into the behavior and performance of the network, enabling users to make informed decisions about how to optimize their infrastructure for their specific needs.

It is noted that all steps outlined in the flow charts of the method are not necessarily required and can be optional. Further, changes to the arrangement of the steps, removal of one or more steps and path connections, and addition of steps and path connections are similarly contemplated.

At step 202, the network system 100 collects flow data from the network switches 120. The flow data can include information about the source and destination of network traffic, the protocol used, and the amount of data transferred. In an implementation, the network switches 120 use the Internet Protocol Flow Information Export (IPFIX) protocol to export flow data to the cloud management platform 110. Processor 122 in each network switch 120 can be configured to collect and export flow data at regular intervals.

At step 204, the network system 100 collects virtualization information from the network switches 120. Virtualization information can include data about the virtual machines (VMs) running on the processing units 140, such as their IP addresses, MAC addresses, and the hypervisor they are running on. In an implementation, the network switches 120 use the Representational State Transfer (REST) architecture to export virtualization information to the cloud management platform 110. Processor 122 in each network switch 120 can be configured to collect and export virtualization information at regular intervals.

The flow data and virtualization information can be stored in the database 118 of the cloud management platform 110. The processor 112 of the cloud management platform 110 can access the stored data and use it to perform various network visualization and optimization tasks.

At step 206, processor 112 of the cloud management platform 110 analyzes the collected flow data and virtualization information to discern individual workloads. A workload is equivalent to a service, and the flows represent the communication between the workloads or services running on the processing units 140. By analyzing the source and destination IP addresses, protocol, and other network flow characteristics, processor 112 can identify which flows belong to each workload or service.

At step 208, processor 112 of the cloud management platform 110 visualizes the communication patterns among the processing units 140 for each identified workload. The visualization can show the data flow between the processing units 140, including the amount of data transferred and the latency of each flow. It can also show the network paths taken by each flow, including the switches and links traversed.

In an implementation, the visualization can be presented as a graph, with the processing units 140 as nodes and the flows as edges. The nodes and edges can be color-coded to represent various metrics. For example, in the case of latency, what is measured is the time that a flow spends in the switch. So, the latency in this case is due to factors within the switch, such as congestion queues. The edges can be color-coded or weighted to indicate the amount of data transferred or the latency of each flow. The interactive graph can allow users to zoom in and out, filter flows based on various criteria, and view additional details about each flow.

At step 210, the network system 100 collects additional network telemetry data to provide detailed visualizations of data flow trajectories. Network telemetry data can include information about the performance and health of the network, such as link utilization, packet loss, and queue depths. In an implementation, the network switches 120 use the In-band Network Telemetry (INT) protocol, such as the Inband Flow Analyzer (IFA) protocol, to collect and export network telemetry data to the cloud management platform 110. Processor 122 in each network switch 120 can be configured to embed telemetry data into the network packets as they traverse the network.

At step 212, processor 112 of the cloud management platform 110 processes the collected network telemetry data to create detailed visualizations of data flow trajectories. The visualizations can show the path taken by each flow through the network, including the switches and links traversed and the performance and health of each network element along the route.

In an implementation, the visualization can be presented as a network topology map, with the switches and links represented as nodes and edges. The nodes and edges can be color-coded or annotated to indicate the performance and health of each network element. The source and destination IP addresses are included as part of the base view. Users can interact with the map to view additional details about each node and edge. For example, for a node representing a switch, users can see details such as when a flow ingresses the switch, the duration it spent at the switch, the interface the flow used, and the queue details. Users can also view additional information about each flow, such as the protocol and application.

At step 214, the network system 100 presents the workload communication patterns and data flow trajectories to the user through the user interface 116 of the cloud management platform 110. The user interface 116 can display the visualizations created in steps 208 and 212, allowing users to explore the network data and gain insights into the behavior and performance of their applications.

The user interface 116 can also provide various tools and features for interacting with the visualizations, such as filtering, searching, and exporting data. Users can use these tools to identify performance bottlenecks, troubleshoot issues, and optimize their network for specific workloads.

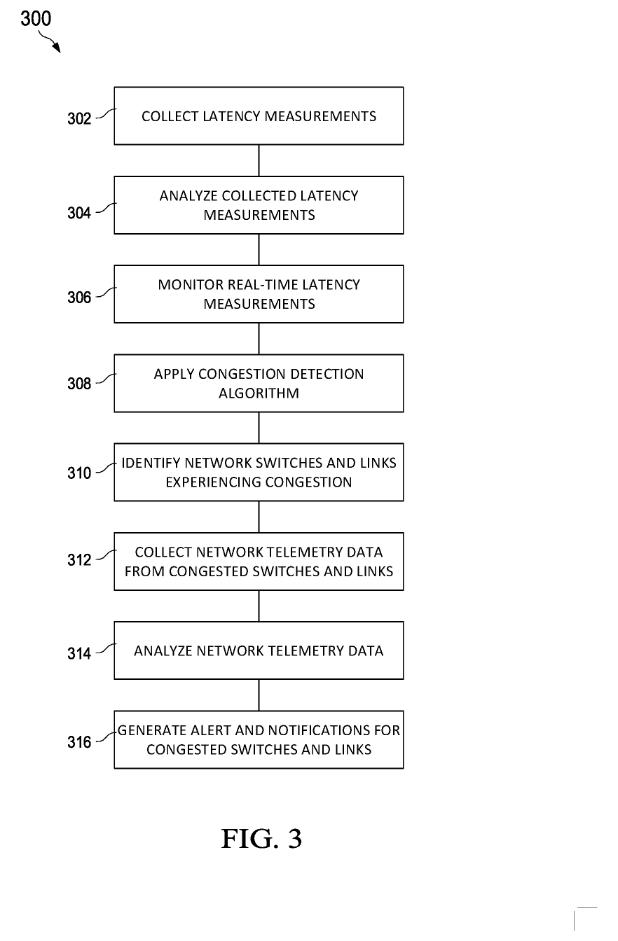

FIG. 3 illustrates a flowchart of an implementation method 300 for dynamic traffic congestion identification. The method 300 can be performed by the network system 100 described in FIG. 1. It provides a comprehensive and automated approach to detecting, analyzing, and alerting network congestion in real time. By collecting and processing latency measurements and other telemetry data from the network switches 120, the network system 100 can quickly identify and diagnose congestion issues and provide actionable insights for remediation and optimization.

It is noted that all steps outlined in the flow charts of the method are not necessarily required and can be optional. Further, changes to the arrangement of the steps, removal of one or more steps and path connections, and addition of steps and path connections are similarly contemplated.

At step 302, the network system 100 collects latency measurements from the network switches 120. Latency measurements can include data about the time packets traverse the network from source to destination and the time spent in queues at each network switch 120. In an implementation, the network switches 120 use the In band Flow Analyzer (IFA) protocol to collect and export latency measurements to the cloud management platform 110. Processor 122 in each network switch 120 can be configured to timestamp packets as they enter and exit the switch and to calculate the latency based on the difference between the timestamps.

At step 304, processor 112 of the cloud management platform 110 analyzes the collected latency measurements to establish a baseline latency profile for the network. The baseline latency profile can represent the expected latency for each path through the network under normal conditions. In an implementation, processor 112 uses statistical techniques such as calculating the mean and standard deviation of the latency measurements over time to establish the baseline latency profile.

At step 306, processor 112 of the cloud management platform 110 monitors the real-time latency measurements collected from network switches 120. Processor 112 can compare the measurements to the baseline latency profile established in step 304 to detect deviations from the expected latency.

At step 308, processor 112 of the cloud management platform 110 applies a congestion detection algorithm to the real-time latency measurements. The congestion detection algorithm can use statistical techniques to determine whether the observed latency measurements differ significantly from the baseline latency profile. In an implementation, processor 112 uses Welford's algorithm to calculate the mean and standard deviation of the latency measurements in real time and compares the current values to the baseline values. If the current values exceed a predefined threshold (e.g., three standard deviations above the baseline mean), processor 112 can flag the corresponding network path as congested.

At step 310, the processor 112 of the cloud management platform 110 identifies the network switches 120 and links experiencing congestion. The processor 112 can use the network topology information stored in database 118, along with the real-time latency measurements, to pinpoint the location of the congestion. In an implementation, the processor 112 can use a graph traversal algorithm to trace the path of the congested flow through the network and identify the switches and links with the highest latency.

At step 312, the network system 100 collects additional network telemetry data from the congested switches and links. The additional telemetry data can include information such as queue depths, link utilization, and packet loss rates, which can help to characterize the nature and severity of the congestion. In an implementation, the network switches 120 use REST to collect and export the additional telemetry data to the cloud management platform 110. In implementations, the network switches 120 store the telemetry data in its database. The processor 122 in each network switch 120 can be configured to mark packets with ECN bits when the switch's queues exceed a certain threshold and to send periodic reports of the queue depths and other metrics to the cloud management platform 110.

At step 314, processor 112 of the cloud management platform 110 analyzes the additional telemetry data collected in step 312 to determine the root cause of the congestion. The root cause can be a hardware issue (e.g., a faulty link or switch), a software misconfiguration (e.g., an incorrect QoS setting), or a traffic pattern (e.g., a sudden surge in traffic from a particular application). In an implementation, the processor 112 can use machine learning techniques such as decision trees or neural networks to analyze the telemetry data and identify patterns indicative of different types of congestion.

At step 316, the network system 100 generates alerts and notifications for the congested switches and links. The alerts can be displayed on the user interface 116 of the cloud management platform 110. They can include information such as the location of the congestion, the severity of the congestion, and the potential impact on applications and users. In an implementation, the alerts can be color-coded based on the severity of the congestion (e.g., red for critical congestion, yellow for moderate congestion, green for no congestion), and can be accompanied by recommended actions for remediation (e.g., adjusting QoS settings, adding more bandwidth, rerouting traffic).

In implementations, the network system 100 stores the congestion data and analysis results in the database 118 of the cloud management platform 110. The stored data can be used for historical analysis, trend detection, and capacity planning. In an implementation, the processor 112 can use the stored data to generate reports and dashboards that show the overall health and performance of the network, as well as the frequency and duration of congestion events over time.

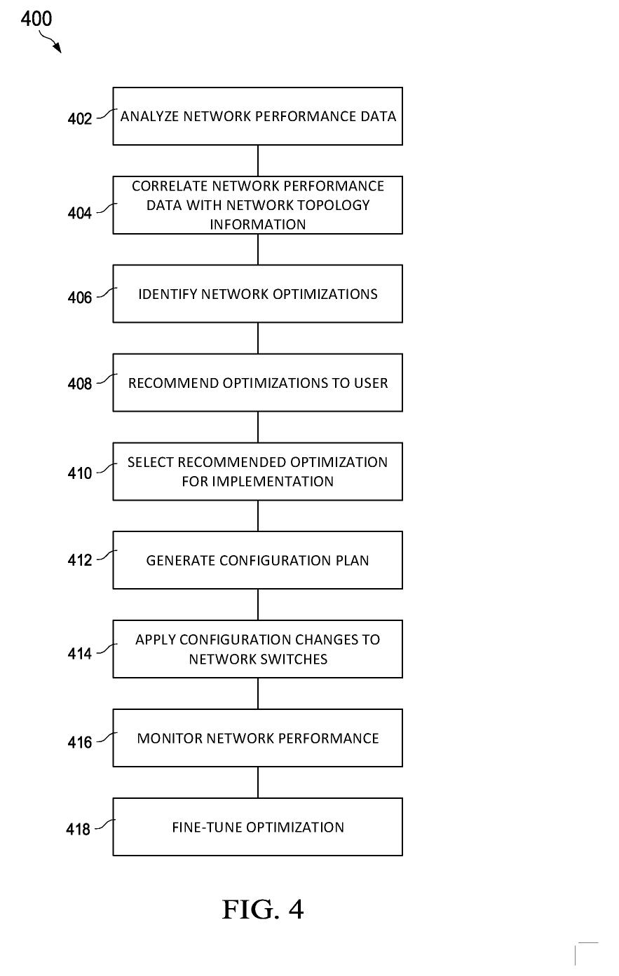

FIG. 4 illustrates a flowchart of an implementation method 400 for network optimization. Method 400 can be performed by the network system 100, as described in FIG. 1. It provides a data-driven and automated approach to optimizing the performance of a network system 100 based on real-time monitoring, analysis, and feedback. By leveraging machine learning, expert systems, and other advanced techniques, method 400 can help network administrators identify and implement optimizations that improve networks' efficiency, reliability, and security while minimizing the risk of disruption to business operations.

It is noted that all steps outlined in the flow charts of the method are not necessarily required and can be optional. Further, changes to the arrangement of the steps, removal of one or more steps and path connections, and addition of steps and path connections are similarly contemplated.

At step 402, processor 112 of the cloud management platform 110 analyzes the network performance data collected from the network switches 120. The network performance data can include latency measurements, congestion alerts, and telemetry data collected by methods 200 and 300. In an implementation, the processor 112 uses machine learning algorithms to identify patterns and anomalies in the network performance data that may indicate opportunities for optimization. In an implementation, processor 112 can use standard deviation calculations to identify congestion and other performance issues in the network. By comparing the current performance metrics to historical baselines and thresholds, processor 112 can detect anomalies and deviations that may indicate optimization opportunities.

At step 404, processor 112 of the cloud management platform 110 correlates the network performance data with the network topology information stored in the database 118. The network topology information can include data about the physical and logical connections between the network switches 120 and the configuration settings of each switch. By correlating the performance data with the topology information, processor 112 can identify specific switches, links, and configurations contributing to suboptimal network performance.

At step 406, processor 112 of the cloud management platform 110 identifies potential network optimizations based on the analysis and correlation performed in steps 402 and 404. The potential optimizations can include changes to the network topology, such as adding or removing links between switches, and changes to the configuration settings of individual switches, such as adjusting QoS settings, buffer sizes, or routing protocols. In an implementation, processor 112 can use a rule-based expert system or a machine learning model to generate optimization recommendations based on historical network performance data and best practices. In an implementation, processor 112 can generate optimization recommendations, such as adjusting QoS settings, buffer sizes, or routing protocols. These recommendations can be based on predefined rules and heuristics that map specific performance issues to corresponding optimization actions.

At step 408, the network system 100 presents the recommended optimizations to the user via the user interface 116 of the cloud management platform 110. The user interface 116 can display the optimization recommendations in a prioritized list, along with explanations of each recommendation's expected benefits and potential risks. In an implementation, the user interface 116 can also provide a simulation tool that allows the user to model the effects of different optimization scenarios on the network performance before applying them in production. This can help users decide which optimizations to implement based on their network requirements and constraints.

At step 410, the user selects one or more of the recommended optimizations to implement via the user interface 116 of the cloud management platform 110. The user can review the details of each recommendation and decide, based on their knowledge of the network and business requirements, whether to accept, modify, or reject it.

In one or more implementations, the network system 100 can automatically apply the recommended optimizations without user intervention based on predefined rules and threshold settings. This can allow for more rapid and consistent network optimization, especially in large-scale environments where manual review and approval of each recommendation may be impractical. The network administrators can configure the predefined rules and thresholds to ensure that the automated optimizations align with the organization's policies and goals.

At step 412, processor 112 of the cloud management platform 110 generates a configuration change plan based on the user-selected optimizations. The configuration change plan can include steps to apply the selected optimizations to the network switches 120 and any necessary precautions or rollback procedures in case of unexpected issues. In an implementation, processor 112 can use a template-based approach to generate the configuration change plan, with predefined templates for common optimization scenarios that can be customized based on the specific network environment.

At step 414, the network system 100 applies the configuration changes to the network switches 120 according to the change plan generated in step 412. The configuration changes can be applied automatically by processor 112 of the cloud management platform 110. In an implementation, the processor 112 can use a staged approach to apply the configuration changes, with a subset of the switches being updated in each stage to minimize the risk of network disruption. In an implementation of step 414, processor 112 can use APIs or CLIs to automatically modify the settings of the network switches 120 based on the user-selected optimizations. This can help to streamline the optimization process and reduce the risk of manual errors or inconsistencies.

At step 416, the network system 100 monitors the network performance after the configuration changes have been applied to verify that the expected optimizations have been achieved. The monitoring can be performed using the same methods and tools as in steps 302 and 312 of method 300, with the processor 112 of the cloud management platform 110 collecting and analyzing latency measurements, congestion alerts, and other telemetry data from the network switches 120. In an implementation, the processor 112 can use statistical process control techniques to detect deviations from the expected performance improvements and trigger alerts if necessary.

At step 418, the network system 100 fine-tunes the optimizations based on the monitoring results performed in step 416. If the expected performance improvements have not been fully realized or new issues have emerged after the configuration changes, processor 112 of the cloud management platform 110 can generate additional optimization recommendations and repeat steps 406-416 as needed.

For example, processor 112 can repeat the optimization steps 406-416 based on the monitoring results performed in step 416. If the expected performance improvements are not fully realized or new issues emerge, processor 112 can generate additional recommendations and apply them iteratively until the desired optimization goals are achieved.

Throughout method 400, the network system 100 can store the optimization recommendations, configuration change plans, and performance data in the database 118 of the cloud management platform 110 for future reference and analysis. The stored data can train machine learning models, identify long-term trends and patterns, and support root cause analysis and troubleshooting of network issues.

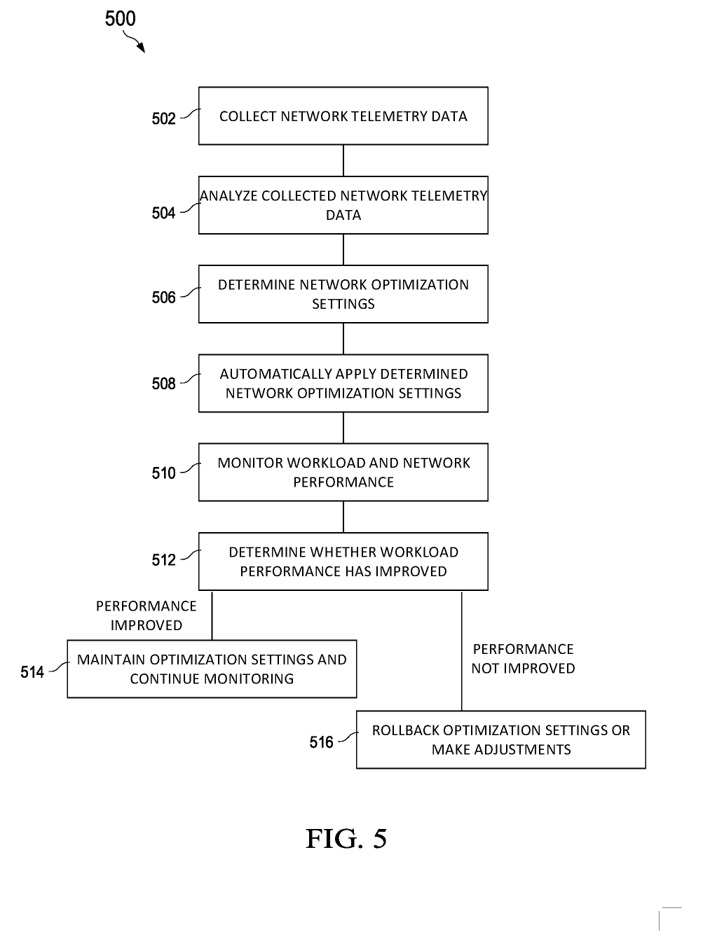

FIG. 5 illustrates a flowchart of an implementation method 500 for optimizing network performance for a workload. Method 500 can be performed by the network system 100 described in FIG. 1, which includes a cloud management platform 110 with a processor 112, memory 114, and a user interface 116, as well as a plurality of network switches 120 and processing units 140.

Method 500 provides an automated and data-driven approach to optimizing network performance for a specific workload based on identifying congestion patterns and the dynamic adjustment of load balancing and flow control settings. The method can be implemented using the components of the network system 100, including the cloud management platform 110, the network switches 120, and the processing units 140, without requiring manual intervention or specialized hardware.

It is noted that all steps outlined in the flow charts of the method are not necessarily required and can be optional. Further, changes to the arrangement of the steps, removal of one or more steps and path connections, and addition of steps and path connections are similarly contemplated.

At step 502, processor 112 collects network telemetry data from the plurality of network switches 120 in the data center. The network telemetry data can include various performance metrics, such as latency, bandwidth, packet loss, and congestion levels, as well as information about the network topology and the configuration settings of the switches. In an implementation, the network switches 120 can use protocols such as REST to export the telemetry data to the cloud management platform 110.

At step 504, processor 112 analyzes the collected network telemetry data to identify congestion related to high-bandwidth data flows between the processing units 140. The processing units 140 can be GPUs, CPUs, or other compute nodes used to run the workload. The high-bandwidth data flows can be caused by the collective communication patterns of the workload, such as all-to-all or many-to-many data exchanges between the processing units 140. In an implementation, the processor 112 can use machine learning algorithms or statistical analysis techniques to detect anomalies or deviations from standard traffic patterns that indicate congestion.

In an implementation, processor 112 can specifically identify congestion caused by collective communication patterns, such as all-to-all data exchanges, where each processing unit 140 sends data to all other processing units in the workload. These communication patterns can generate significant network traffic and lead to congestion, especially when dealing with large-scale workloads involving many processing units.

At step 506, processor 112 dynamically determines network optimization settings based on the identified congestion. The network optimization settings can include load balancing parameters, such as the distribution of traffic across multiple paths or the assignment of flows to specific queues, as well as flow control adjustments, such as the configuration of QoS policies, buffer sizes, or congestion notification thresholds. In an implementation, the processor 112 can use a rule-based system or a heuristic algorithm to map the identified congestion patterns to specific optimization settings based on predefined policies or best practices.

In an implementation, processor 112 can use a combination of predefined rules and heuristics to determine the appropriate optimization settings based on the identified congestion patterns. For example, processor 112 can have rules that map specific congestion scenarios (e.g., high latency between certain processing units) to corresponding optimization actions (e.g., increasing the priority of specific traffic flows). These rules can be based on best practices, expert knowledge, or historical data analysis.

At step 508, processor 112 automatically applies the determined network optimization settings to the affected network switches 120. The affected switches can be identified based on their involvement in the congested data flows or proximity to the processing unit 140 experiencing the congestion. In an implementation, processor 112 can use APIs, CLIs, or other management interfaces to remotely configure the switches with the optimization settings. Processor 112 can also use a staged rollout approach to gradually apply the settings to different switch subsets to minimize the disruption risk.

In an implementation, processor 112 can apply the optimization settings to the affected network switches 120 in a targeted manner, focusing on the switches directly involved in the congested data flows or connected to the processing units 140 experiencing the congestion. This targeted approach can help to minimize the impact of the optimization changes on the rest of the network and reduce the risk of unintended consequences.

At step 510, processor 112 monitors the workload and network performance after applying the optimization settings. The monitoring can involve collecting additional telemetry data from the switches and the processing units and analyzing metrics such as job completion time, throughput, and resource utilization. In an implementation, the processor 112 can use a feedback loop to continuously adjust the optimization settings based on the observed performance improvements or degradations.

At step 512, processor 112 determines whether the workload's performance has improved due to the applied optimization settings. The determination can be based on comparing the monitored performance metrics to predefined thresholds or historical baselines.

If the performance has improved, method 500 can proceed to step 514, where the optimization settings are maintained and the monitoring continues.

If the performance has not improved, method 500 can proceed to step 516, where the optimization settings are rolled back or adjusted based on the monitoring results. Processor 112 can generate a report or notification to inform users about the optimization process results. The report can include details about the identified congestion patterns, the applied optimization settings, and the observed performance improvements or degradations. The report can also include recommendations for further optimizations or troubleshooting steps based on the analysis of the telemetry data and the monitoring results.

In an implementation, processor 112 can store the results of the optimization process, including the identified congestion patterns, the applied optimization settings, and the observed performance improvements or degradations, in the memory 114 or a separate database. The stored data can be used for various purposes, such as conducting further analysis to identify trends, correlations, or root causes of network performance issues, training machine learning models to improve the accuracy and efficiency of future optimization decisions, generating reports or visualizations to help network administrators understand the effectiveness of the optimization process and identify areas for further improvement, or the like.

Through method 500, processor 112 can store the collected telemetry data, the determined optimization settings, and the monitoring results in the memory 114 or a separate database. The stored data can be used for further analysis, machine learning, or reporting.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Where appropriate, any suitable operation or sequence described or illustrated herein may be interrupted, suspended, or otherwise controlled by another process, such as an operating system or kernel. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. Therefore, the appended claims are intended to encompass any such modifications or implementations.

What is claimed is:

1. A computer system for optimizing network performance for a workload, the computer system comprising:
a plurality of network switches, each network switch comprising a switch processor; and
a cloud management platform comprising:
a non-transitory memory storage comprising instructions; and
a management processor in communication with the non-transitory memory storage, wherein the management processor executes the instructions to:
collect network telemetry data from the plurality of network switches,
analyze the network telemetry data to identify congestion related to high-bandwidth data flows between processing units,
dynamically determine network optimization settings based on the identified congestion, including load balancing parameters and flow control adjustments, and
automatically apply the network optimization settings to affected network switches to improve workload performance.

2. The computer system of claim 1, wherein the management processor executes the instructions to monitor the network performance post-optimization to ensure sustained efficiency.

3. The computer system of claim 1, wherein the workload is an artificial intelligence/machine learning workload involving distributed training or inference across multiple graphics processing units (GPUs).

4. The computer system of claim 1, wherein the switch processor in each network switch collects network telemetry data, including latency measurements, queue depths, port utilization statistics, and network flow information.

5. The computer system of claim 1, wherein the management processor executes the instructions to use machine learning algorithms or statistical analysis techniques to detect anomalies or deviations from standard traffic patterns that indicate congestion.

6. The computer system of claim 1, wherein the management processor executes the instructions to use a combination of predefined rules and heuristics to map the identified congestion patterns to specific optimization settings based on best practices, expert knowledge, or historical data analysis.

7. The computer system of claim 1, wherein the management processor executes the instructions to apply the optimization settings to the affected network switches in a targeted manner by focusing on the switches directly involved in the congested data flows or connected to the processing units experiencing the congestion.

8. The computer system of claim 1, wherein the management processor executes the instructions to generate visual representations of network conditions and traffic patterns.

9. The computer system of claim 1, wherein the management processor executes the instructions to present the recommended optimizations to a user via a user interface.

10. The computer system of claim 1, wherein the management processor executes the instructions to automatically apply the recommended optimizations without user intervention based on predefined rules and threshold settings configured by network administrators.

11. A non-transitory computer-readable media storing computer instructions that, when executed by a management processor in a cloud management platform, cause the management processor to:
identify one or more workloads in a data center network based on analysis of network flow data and virtualization information collected from a plurality of network switches;
monitor network latency across the plurality of network switches for data flows associated with the identified workloads;
detect network congestion using statistical analysis of the monitored network latency;
dynamically determine network optimization parameters in response to the detected congestion; and
implement the network optimization parameters across one or more of the plurality of network switches to mitigate congestion for the workload.

12. The non-transitory computer-readable media of claim 11, wherein the instructions cause the management processor to use data from switch processors in the network switches to obtain per-hop latency measurements for analysis.

13. The non-transitory computer-readable media of claim 11, wherein the instructions cause the management processor to establish a dynamic latency baseline and flag congestion when the measured latency exceeds an adaptive threshold based on the baseline.

14. The non-transitory computer-readable media of claim 11, wherein the instructions cause the management processor to generate alerts and notifications for the congested switches and links.

15. The non-transitory computer-readable media of claim 11, wherein the instructions cause the management processor to store the congestion data and analysis results in a database.

16. The non-transitory computer-readable media of claim 11, wherein the instructions cause the management processor to generate a configuration change plan based on the determined optimization parameters.

17. The non-transitory computer-readable media of claim 11, wherein the instructions cause the management processor to automatically modify the settings of the network switches based on the determined optimization parameters.

18. A computer-implemented method for optimizing network performance for a workload, the computer-implemented method comprising:
identifying, by a management processor in a cloud management platform, one or more workloads in a data center network based on analysis of network flow data and virtualization information collected from a plurality of network switches;
monitoring, by the management processor, network latency across the plurality of network switches for data flows associated with the identified workloads;
detecting, by the management processor, network congestion using statistical analysis of the monitored network latency;
dynamically determining, by the management processor, network optimization parameters in response to the detected congestion; and
implementing, by the management processor, the network optimization parameters across one or more of the plurality of network switches to mitigate congestion for the workload.

19. The computer-implemented method of claim 18, further comprising:
collecting, by switch processors in the network switches, additional network telemetry data from congested switches and links, such as queue depths, link utilization, and packet loss rates;
analyzing, by the management processor, the additional telemetry data to determine the root cause of the congestion, such as hardware issues, software misconfigurations, or traffic patterns; and
adjusting, by the management processor, the optimization parameters based on the root cause analysis.

20. The computer-implemented method of claim 18, further comprising:
monitoring, by the management processor, the workload and network performance after applying the optimization settings;
continuously adjust, by the management processor, the optimization settings using a feedback loop based on the observed performance improvements or degradations;
storing, by the management processor, the optimization results, including the identified congestion patterns, applied optimization settings, and performance improvements or degradations, in a database;
analyzing, by the management processor, the stored data using machine learning; and
improving, by the management processor, the accuracy and efficiency of future optimization decisions based on the analyzing of the stored data.
